(19) United States
(12) Patent Application Publication
(10) Pub. No.: US 2014/0152588 A1
(43) Pub. Date: Jun. 5, 2014

(54) FLEXIBLE TOUCH SCREEN PANEL AND FABRICATING METHOD THEREOF

(71) Applicant: SAMSUNG DISPLAY CO., LTD., Yongin-City (KR)

(72) Inventors: Sung-Ku Kang, Yongin-City (KR); Byeong-Kyu Jeon, Yongin-City (KR); Hee-Woong Park, Yongin-City (KR)

(73) Assignee: Samsung Display Co., Ltd., Yongin-City (KR)

(21) Appl. No.: 13/863,763

(22) Filed: Apr. 16, 2013

(30) Foreign Application Priority Data
Nov. 30, 2012 (KR) 10-2012-0138196

(51) Int. Cl. G06F 3/041

(52) U.S. Cl. CPC G06F 3/041
USPC 345/173; 427/98.4; 427/97.4

(57) ABSTRACT

The present invention relates to a flexible touch screen panel. A flexible touch screen panel includes a substrate, first sensing cells formed on the substrate and connected to each other in a first direction, second sensing cells formed on the substrate and connected to each other in a second direction intersected with the first direction, first connection patterns connecting the first sensing cells to each other in the first direction, and second connection patterns connecting the second sensing cells to each other in the second direction. The first connection patterns include at least one opening part.

### CLAIM OF PRIORITY

This application makes reference to, incorporates the same herein, and claims all benefits accruing under 35 U.S.C. §119 from an application earlier filed in the Korean Intellectual Property Office on Nov. 30, 2012 and duly assigned Serial No. 10-2012-0138196.

### BACKGROUND OF INVENTION

1. Field of the Invention

Embodiments of the present invention generally relate to a touch screen panel and a fabricating method thereof, and more particularly, to a flexible touch screen panel and a fabricating method thereof.

2. Description of the Related Art

A touch screen panel is an input device capable of inputting a user's instruction by selecting instruction contents displayed on a screen of an image display device, or the like, with a human hand or an object.

To this end, the touch screen panel is provided on a front face of the image display device to convert a contact position that the human hand or the object directly contacts into an electric signal. Therefore, an instruction content selected at the contact position is recognized as an input signal.

Since the touch screen panel as described above may replace a separate input device connected to the image display device, such as a keyboard and a mouse, a use range of the image display device has gradually increased.

As a scheme of implementing the touch screen panel, there are a resistive type scheme, an optical sensing type scheme, a capacitive type scheme, and the like. For instance, when a contact object such as a human hand, a stylus pen, or the like, contacts a capacitive type touch screen panel, the capacitive type touch screen panel senses a change in capacitance of a capacitor formed by a conductive sensing cell and a respective surrounding sensing cell, a ground electrode, or the like, and converts the contact position into an electric signal.

To this end, the capacitive type touch screen panel is configured to include first sensing cells formed to be connected to each other in a first direction, second sensing cells formed to be connected to each other in a second direction, first connection patterns for connecting the first sensing cells in the first direction, and second connection patterns for connecting the second sensing cells in the second direction.

The touch screen panel as described above is generally fabricated by adhering on an outer surface of an image display device such as a liquid crystal display (LCD) and an organic light emitting diode (OLED) display. Therefore, the touch screen panel is preferred to have a high transparency and a thin thickness. More particularly, the sensing cells and connection patterns of the touch screen panel should not be visible to users.

Recently, a flexible image display device has been developed. Consequently, flexibility of the touch screen panel adhered thereon has been required as well.

However, the touch screen panel may have a structure which includes the sensing cells formed of a transparent conductive material such as an indium tin oxide (ITO) on a rigid glass substrate. In this case, the flexibility may not be satisfied.

In order to apply the touch screen panel according to the contemporary art to the flexible image display device, a method of using a flexible thin film such as polyethyleneterephthalate (PET) material, or the like, as the substrate of the touch screen panel has been proposed. However, in this case, there is a limitation in controlling a size, a width, or the like, of the sensing cells and connection patterns formed on the flexible thin film. Particularly, since the connection patterns are formed in a form in which they have narrow widths than those of the sensing cells, conditions such as a predetermined surface resistance as well as transmittance need to be considered.

To this end, in the case in which the touch screen panel according to the contemporary art is fabricated using the glass substrate, the first or second connection patterns are made of an opaque metal having a thin wire shape. However, in the case in which the flexible touch screen panel is fabricated using the thin film, it is difficult to perform a high temperature process to make the opaque metal due to a relatively poor heat resistance of the thin film, and thus, there is a limitation in decreasing the width of the connection pattern.

Adversely, a visibility problem that the connection patterns of the flexible touch screen panel are visible to users has been generated. Therefore, a scheme of capable of improving the visibility by preventing the connection patterns of the flexible touch screen panel from being visible to users is required.

### SUMMARY OF THE INVENTION

An object of the present invention is to provide a flexible touch screen panel capable of improving a visibility by preventing connection patterns from being visible to users and a fabricating method thereof.

In order to achieve the object described above, according to one aspect of the present invention, there is provided a flexible touch screen panel comprising a substrate, first sensing cells formed on the substrate and connected to each other in a first direction, second sensing cells formed on the substrate and connected to each other in a second direction intersected with the first direction, first connection patterns connecting the first sensing cells to each other in the first direction, and second connection patterns connecting the second sensing cells to each other in the second direction.

The first connection patterns may include at least one opening part.

The first connection patterns may be implemented as a porous pattern having a plurality of opening parts formed therein.

The first connection patterns may be made of one or more selected from a group consisting of opaque metal material, conductive thin film, silver nanowire (AgNW) conductive thin film, and indium tin oxide (ITO) conductive thin film.

An insulation film may be interposed between the first connection patterns and the second connection patterns at an intersection portion therebetween.

The substrate may be implemented as a film substrate having flexibility.

The substrate may be a thin film substrate and made of one or more material selected from a group consisting of polyethylene terephthalate (PET), polycarbonate (PC), triacetylcellulose (TAC), polyethersulpon (PES), and polyimide (PI).

Each of the first connection patterns may include a contact area overlapping the first sensing cells and a non-contact area defined as a remaining area with the exception of the contact area, and the at least one opening part is formed in the non-contact area.

The at least one opening part may be formed in the contact area as well as the non-contact area.

The at least one opening part may consist of a plurality of opening parts uniformly disposed in each of the first connection patterns including the contact area and the non-contact area.

According to another aspect of the present invention, there is provided a fabricating method of a flexible touch screen panel forming, on a substrate, first sensing cells, second sensing cells, first connection patterns connecting the first sensing cells to each other in a first direction and second connection patterns connecting the second sensing cells to each other in a second direction. The fabricating method includes forming a conductive thin film on the substrate, disposing a first mask layer on an area of the conductive thin film, corresponding to an area to be formed the first connection patterns, forming the first connection patterns by patterning the conductive thin film by the first mask layer and removing the first mask layer, disposing a second mask layer having at least one opening part formed at an upper portion of the first connection patterns on the substrate on which the first connection patterns are formed, and forming at least one opening part in the first connection patterns by using the second mask layer and removing the second mask layer.

Each of the first and second mask layers may be a temporarily hardened dry film resistor.

Each of the first and second mask layers may be disposed on the conductive thin film or on the substrate in which the first connection patterns are formed by laminating the dry film resistor.

The resistor having the at least opening part may be disposed on the entire surface of the substrate in which the first connection patterns are formed.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a plan view showing a touch screen panel constructed as an embodiment according to the principles of the present invention;

FIG. 2 is a plan view of main portion showing sensing cells and connection patterns constructed as the embodiment according to the principles of the present invention;

FIGS. 3A and 3B are plan views showing an example of first connection patterns constructed as the embodiment according to the principles of the present invention; and

FIGS. 4A through 4E are plan views and side cross-sectional views correspondingly showing a fabricating method of a flexible touch screen panel constructed as the embodiment according to the principles of the present invention, and more particularly, sequentially showing forming of a first connection patterns on a substrate.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

Hereinafter, embodiments of the present invention will be described in detail with reference to the accompanying drawings.

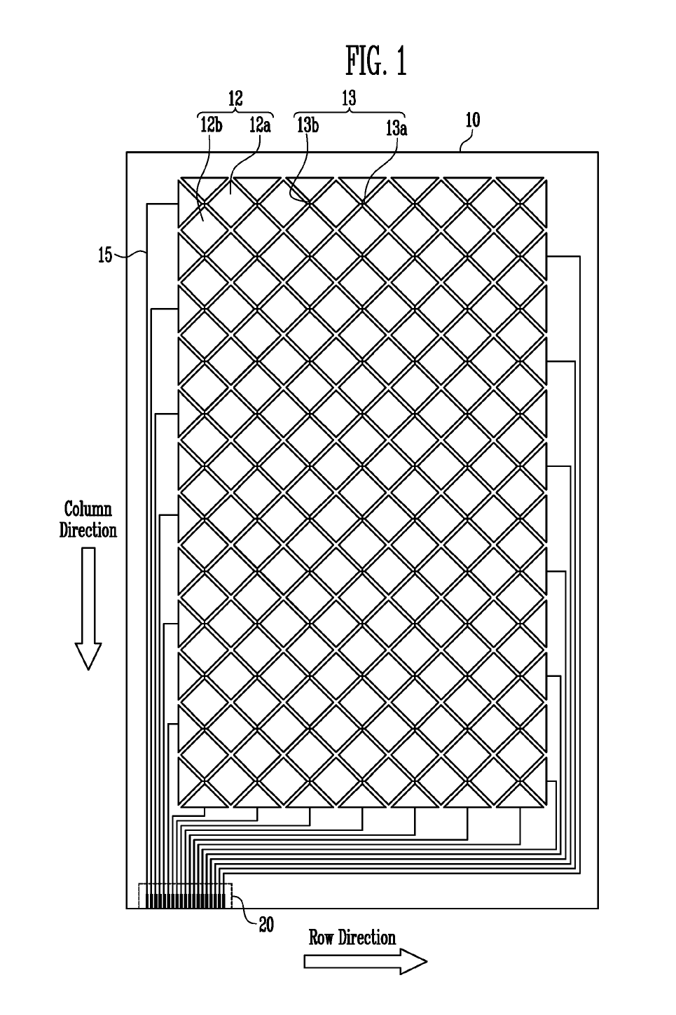

FIG. 1 is a plan view showing a touch screen panel constructed as an embodiment according to the principles of the present invention.

Referring to FIG. 1, the touch screen panel constructed as an embodiment according to the principles of the present invention is configured to include a substrate 10, sensing cells 12 formed on a touch active area of the substrate 10, connection patterns 13 for connecting the sensing cells 12 in a first direction and/or a second direction, and position detecting lines 15 formed on a touch non-active area of the substrate 10 and connecting the sensing cells 12 to an external driving circuit through a pad part 20.

The substrate 10, which is a base material of the touch screen panel, may be implemented as a substrate having transparency and flexibility, for example, a film substrate which is formed in a thin film shape in order to implement a flexible touch screen panel. To this end, as an example, the substrate 10 may be made of at least one material selected from a group consisting of polyethylene terephthalate (PET), polycarbonate (PC), triacetylcellulose (TAC), polyethersulpon (PES), and polyimide (PI).

The sensing cells 12 are made of a transparent electrode material such as an indium tin oxide (ITO) and include a plurality of first sensing cells 12a formed to be connected to each other in the first direction and a plurality of second sensing cells 12b formed to be connected to each other in the second direction intersecting with the first direction (for example, perpendicular to the first direction). The first sensing cells 12a and second sensing cells 12b are alternately distributed so as not to overlap with each other, and may be disposed on the touch active area.

That is, the plurality of first sensing cells 12a are disposed in a row-line and/or a column-line, respectively. The plurality of first sensing cells 12a positioned in the same row-line or the same column-line (the row-line in the present embodiment) are formed to be connected to each other in the first direction (a row direction in the present embodiment) by a plurality of first connection patterns 13a disposed in the same row-line or the same column-line. At this time, the first sensing cells 12a are connected to the position detecting lines 15 in a row-line unit connected to each other in the first direction, respectively.

That is, the plurality of second sensing cells 12b are disposed in the column-line and/or the row-line, respectively The plurality of second sensing cells 12b positioned in the same column-line or the same row-line (the column line in the present embodiment) are formed to be connected to each other in the second direction (a column direction in the present embodiment) intersecting with the first direction by the plurality of second connection patterns 13b disposed in the same column-line or the same row-line. At this time, the second sensing cells 12b are connected to the position detecting lines 15 in a column-line unit connected to each other in the second direction, respectively.

The connection patterns 13 include the plurality of first connection patterns 13a formed in the first direction and connecting the first sensing cells 12a to each other in the first direction and the plurality of second connection patterns 13b formed in the second direction and connecting the second sensing cells 12b to each other in the second direction. The connection patterns 13 as described above may be integrally formed using the same material as the sensing cells 12. Alternatively, the connection patterns 13 may be formed of a separate opaque metal pattern with low electrical resistance to electrically connect to the sensing cells 12.

The position detecting lines 15 are electrically connected to the first sensing cells 12a in the row-line unit connected to each other in the first direction and the second sensing cells 12b in a column-line unit connected to each other in the second direction, to connect the first and second sensing cells 12a and 12b to the external driving circuit (not shown) such as a position detecting circuit through the pad part 20.

These position detecting lines 15, which are disposed in the touch non-active area defined to an outside portion of the touch active area rather than the touch active area in which an image is displayed, may be made of a variety of materials. That is, in addition to the transparent electrode material used to form the sensing cells 12, the position detecting lines 15 may be made of a low resistance material such as chrome (Cr), nickel (Ni), molybdenum (Mo), silver (Ag), titanium (Ti), copper (Cu), aluminum (Al), molybdenum/aluminum/molybdenum (Mo/Al/Mo), and the like.

The touch screen panel constructed as the embodiment according to the principles of the present invention as described above is a capacitive type touch panel. When a contact object such as a human hand, a stylus pen, or the like, contacts the touch screen panel, a change in capacitance according to a contact position is transferred from the sensing cells 12 to the driving circuit (not shown) via the position detecting lines 15 and the pad part 20. In this case, the change in capacitance is converted into an electrical signal by X and Y input processing circuits, or the like (not shown), such that the contact position is recognized.

The touch screen panel is generally fabricated by adhering on an outer surface of an image display device. In order not to deteriorate the image quality of the image display device, the image display device may be required to have a high transparency and a thin thickness.

To this end, the sensing cells 12 may be formed using a transparent electrode material such as indium tin oxide (ITO) in order to ensure the transparency of the touch screen panel, and the first and second sensing cells 12a and 12b are disposed on a same layer in order to avoid increasing the thickness of the touch screen panel.

However, the first and second sensing cells 12a and 12b are connected in different directions from each other by the first and second connection patterns 13a and 13b, respectively, such that the first and second connection patterns 13a and 13b are intersected to each other. Accordingly, in the case in which the first and second sensing cells 12a and 12b are disposed on the same layer, it is difficult that at least one of the first and second connection patterns 13a and 13b are formed integrally with the first and second sensing cells 12a and 12b during the process forming the sensing cells 12. Therefore, the first or second connection patterns 13a or 13b are separately formed from the first or second sensing cells 12a or 12b connected therewith to electrically connect thereto. For example, the first connection patterns 13a are formed by a separate process different from the process of forming the sensing cells 12 to electrically connect to the first sensing cells 12a, and the second connection patterns 13b may be integrally formed to electrically connect to the second sensing cells 12b during the process of forming the sensing cells 12. However, the present invention is not limited thereto. For example, the second connection 13b may also be formed separately from the sensing cells 12. In addition, an insulation film (not shown) may be interposed at crossed portion of the first and second connection patterns 13a and 13b in order to secure stability and prevent short-circuits therebetween.

Since the connection patterns 13 are formed to have relatively narrow widths than those of the sensing cells 12, it is important to ensure the surface resistance condition. For this, the first connection patterns 13a, which is formed separately from the sensing cells 12, are made of the opaque metal pattern with low resistance formed in a thin wire shape, such that the conditions such as the predetermined transmittance and surface resistance may still be met while preventing the pattern from being seen by users.

In the case in which the touch screen panel according to contemporary art is fabricated using the glass substrate, it is possible to perform the process of patterning the first connection patterns 13a at a width of about 5 μm. However, in order to manufacture the flexible touch screen panel, the substrate 10 is preferred to have high flexibility. For instance, the substrate 10 may be made of at least one material selected from a group consisting of polyethylene terephthalate (PET), polycarbonate (PC), triacetylcellulose (TAC), polyethersulpon (PES), and polyimide (PI). However, there is a limitation in decreasing the width of the first connection patterns 13a if the substrate 10 is formed at least one of the aforementioned materials. Therefore, in the case in which the flexible touch screen panel constructed as the embodiment according to the principles of the present invention is fabricated using the thin film, it is difficult to perform a high temperature process due to a relatively poor resistance of the thin film. As a result, there is a limitation in decreasing the width of the connection patterns 13a.

Therefore, according to the embodiment of the present invention, the flexible touch screen panel using the substrate having the flexibility, for example, the thin film as the substrate of the touch screen panel is implemented here, an opening part is formed in each of the first connection patterns 13a, such that the connection patterns 13a may be prevented from being visible to a user and also ensure the predetermined transmittance even in the case in which the widths of the first connection patterns 13a may be too wide to be visible to users.

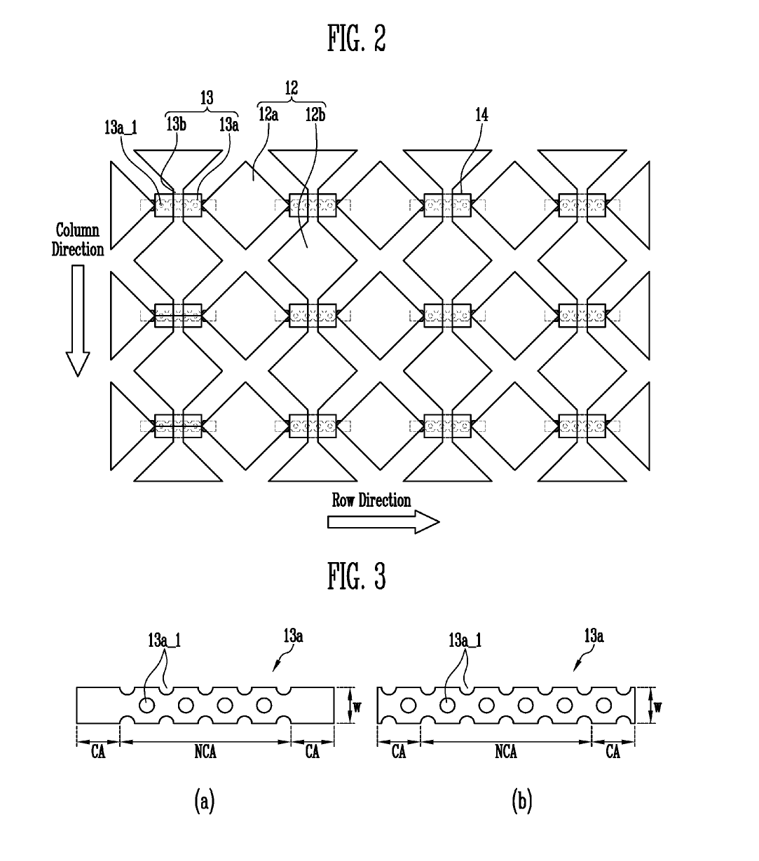

The flexible touch screen panel and the fabricating method thereof according to the embodiments of the present invention will be described in detail with reference to FIGS. 2 through 4E.

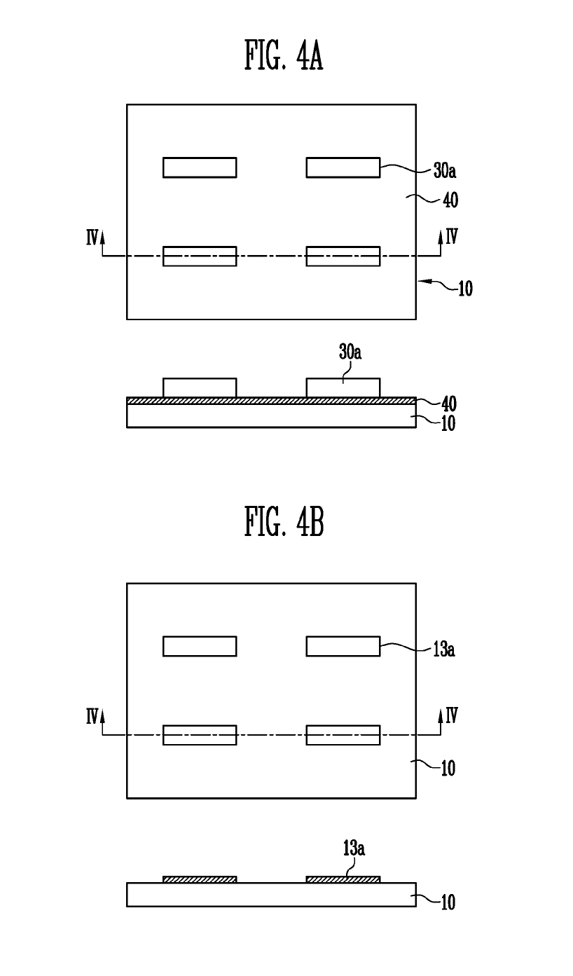

FIG. 2 is a plan view of a main portion of a touch screen panel showing sensor cells and connection patterns, constructed as an embodiment according to the principles of the present invention. FIGS. 3A and 3B are plan views showing an example of first connection patterns constructed as the embodiment according to the principles of the present invention.

First, referring to FIG. 2, the first connection patterns 13a are formed as a separate pattern from the first sensing cells 12 and formed to be electrically connected to the first sensing cells 12a, and the second connection patterns 13b may be formed to be connected integrally the second sensing cells 12b with the second sensing cells 12b. In addition, an insulation film 14 is formed at crossed portion of the first and second connection patterns 13a and 13b in order to secure stability and prevent short-circuits therebetween. That is, the insulation film 14 is interposed between the first and second connection patterns 13a and 13b to electrically insulate each other.

Meanwhile, although the present embodiment describes a case in which the first connection patterns 13a are disposed under the insulation film 14 and the second connection pattern 13b, by way of example, the present invention is not limited thereto. For example, the first connection patterns 13a may be disposed on an upper portion the second connection patterns 13b and the insulation film 14.

According to the embodiment of the present invention, each of the first connection patterns 13a includes at least one opening parts 13a_1. For example, the first connection patterns 13a may be implemented as a porous pattern having a plurality of opening parts 13a_1 formed therein.

As shown in FIG. 3A, the opening part 13a_1 as described above may be formed in at least non-contact area NCA in the first connection patterns 13a. Here, the non-contact area NCA may be defined as a remaining area with the exception of a contact area CA overlapping the first sensing cells 12a and first connection patterns 13a with each other.

The opening part 131a_1 according to the embodiment of the present invention need not be formed only in the non-contact area NCA, for example, the opening part 131a_1 may also be formed in the contact area CA together with the non-contact area NCA as shown in FIG. 3B. As an example, the plurality of opening part 131a_1 may be entirely uniformly disposed in each of the first connection patterns 13a including the contact area CA and non-contact area NCA. In addition, the opening part 131a_1 according to the embodiment of the present invention may be formed not only in the first connection patterns 13a but also in the second connection patterns 13b.

As described above, according to the characteristics of the present invention, the opening parts 131a_1 are formed at the first connection patterns 13a. In the case in which the opening parts 131a_1 are formed in the first connection patterns 13a, the transmittance is improved and the first connection patterns 13a is prevented from being visible to a user, a limitation in the width (W) and material is decreased as compared with the comparative example in which the opening part 131a_1 is not formed.

Even in the case in which the first connection patterns 13a are formed to have the width W, for example, the width W of about 30·m at which the patterning may be stably performed even through the low temperature process on the substrate 10, thereby making it possible to prevent the deterioration of visibility in the first connection patterns 13a.

In addition, the first connection patterns 13a having the opening parts 13a_1 formed therein may be made of a variety of materials. That is, the opaque metal material with the low resistance or the conductive material which is equal or less than the predetermined transmittance may be selected as the material for forming the first connection patterns 13a. For example, the first connection patterns 13a may be made of a conductive thin film of the opaque metal material with the low resistance, silver nanowire (AgNW) conductive thin film, indium tin oxide (ITO) conductive thin film, or the like, capable of being used to form the position detecting line. That is, the first connection patterns 13a are made of at least one conductive thin film selected from a group consisting of conductive thin film of the opaque metal material, the silver nanowire (AgNW) conductive thin film, and the indium tin oxide (ITO) conductive thin film.

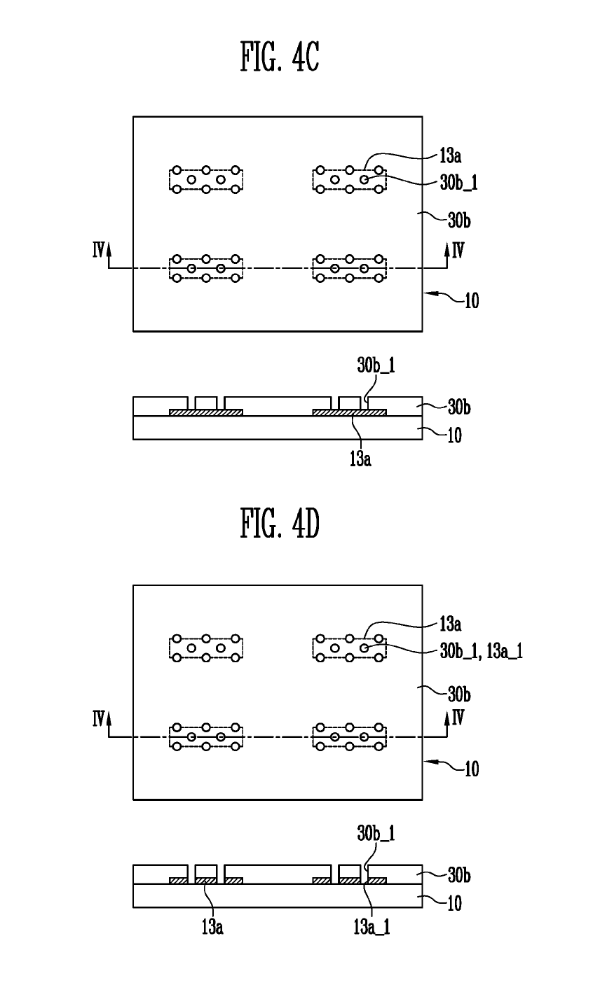

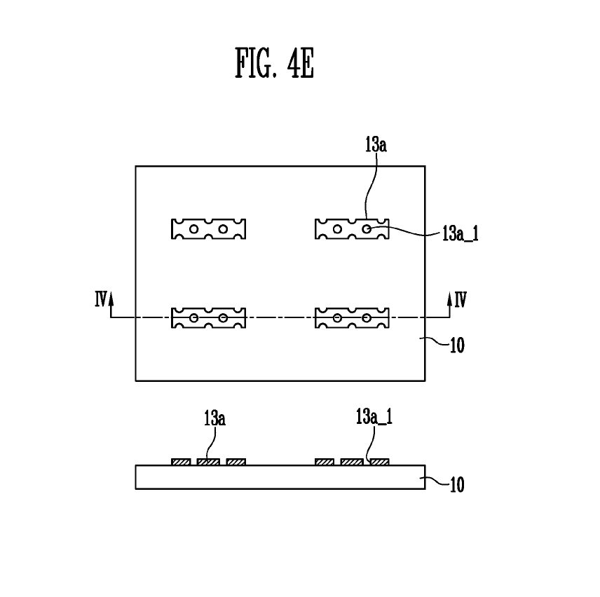

FIGS. 4A through 4E are plan views and side cross-sectional views corresponding thereto showing a fabricating method of a flexible touch screen panel constructed as the embodiment according to the principles of the present invention, and more particularly, sequentially showing forming of a first connection patterns on a substrate. In addition, each of FIGS. 4A through 4E includes a plan view (upper part of the figure) and a side cross-sectional view (bottom part of the figure) taken along line Iv-Iv shown in the plan view. That is, FIGS. 4A through 4E are plan and side cross-sectional views sequentially showing only the forming the first connection patterns, which is a characteristic configuration of the fabricating method of the flexible touch screen panel forming the first and second sensing cells and the first and second connection patterns on the substrate.

Sequentially describing the forming the first connection patterns as described above, as shown in FIG. 4A, a conductive thin film 40 will be first formed on entire substrate 10, and a first mask layer 30a is disposed on the conductive thin film 40 corresponding to the area in which the first connection patterns 13a may be formed. The first mask layer 30a may be formed of a temporarily hardened dry film resistor capable of performing a low temperature process within a safe range at which the substrate 10 may be sustained.

More specifically, the first mask 30a may be disposed on the conductive thin film 40 by lamination using heat and pressure. The ranges of the heat and pressure applied should be within the ranges that the substrate 10 can be sustained. In other words, the material properties of the substrate 10, such as surface flatness, surface roughness, light reflectance, and light transmittance, are not changed after the heat and pressure are applied; or the change of the material properties of the substrate 10 are within a tolerate range. Since in the subsequent process according to the embodiments of the present invention, transmittance in the connection pattern regions may be ensured by the opening parts formed in the first connection patterns, it is possible that the first connection patterns with opening parts have the width larger than that of the first connection patterns without opening parts to keep the transmittance in the predetermined range. Therefore, the first connection patterns may have a certain width, for example, 30·m, which is wide enough to stably prevent the first mask layer 30a from being removed during the subsequent patterning process using the first mask layer 30a, for example, a developing process or an etching process.

Then, as shown in FIG. 4B, the first connection patterns 13a is formed by patterning the conductive thin film 40 with the first mask layer 30a and then the first mask layer 30a which is attached to the upper portion of the first connection patterns 13a is removed. Here, the process patterning the conductive thin film 40 with the first mask layer 30a may include a developing process, an etching process, and the like. Preferably, a dry film resistor may be used to form the first mask layer 30a. When the pattering of the conductive thin film 40 is completed, the first mask layer 30a may be removed by peeling.

Then, as shown in FIG. 4C, on the substrate 10 having the first connection patterns 13a, a second mask layer 30b having one or more opening parts 30b_1 at portions corresponding to the first connection patterns 13a is entirely disposed. Here, the second mask layer 30b may be, for example, a dry film resistor or a liquid photo resistor, and in the embodiment according to the present invention, the dry film resistor is entirely formed by lamination. Here, although the second mask layer 30b having relatively low adhesion is laminated, the entire formation of the second mask layer 30b may prevent the second mask layer 30b from being removed in the subsequent etching process.

Then, as shown in FIG. 4D, the first connection patterns 13a, which are locally etched using the dry film resistor as the second mask layer 30b, have opening parts 13a_1.

Then, as shown in FIG. 4E, when the second mask layer 30b is removed through the peeling process. The patterning of the first connection patterns 13a is completed.

Meanwhile, although the embodiments of the present invention have disclosed the case in which the first and second mask layers 30a and 30b are used, respectively, in two different steps, that is, pattering outside portions of the first connection patterns 13a and forming the opening parts the first connection patterns 13a, the present invention is not limited thereto. For example, patterning the outside portion of the first connection patterns 13a and forming opening parts 13a_1 in the first connection patterns 13a may be simultaneously performed in one step using a single mask layer which is formed of a dry film resistor. The single mask layer has a size corresponding to the first connection patterns 13a, and the single mask also includes opening parts which are used to form the opening parts 13a_1 in the first connection patterns.

Although not shown in FIGS. 4A through 4D, the sensing cells 12 and the second connection patterns 13b may be formed simultaneously by same processes before or after forming the first connection patterns 13a. The processes for forming the insulation film 14 may be performed between the processes for forming the sensing cells 12 and the second connection patterns 13b and the processes for forming the first connection patterns 13a. Alternatively, the processes for forming the second connection patterns 13b may be performed differently from the processes for forming the sensing cells 12, and thus, the processes for forming the insulation film 14 may be performed between the processes for forming the first connection patterns 13a and the processes for forming the second connection patterns 13b. In addition, the processes for fabricating the second connection patterns may be similar to or the same as the aforementioned processes for fabricating the first connection patterns; therefore, the processes for fabricating the second connection patterns are not repeated here.

As set forth above, with the flexible touch screen panel and the fabricating method thereof, the flexible touch screen panel is implemented using the substrate having the flexibility, for example, the film substrate which is formed in a thin film shape as the substrate of the touch screen panel, and the opening part is formed at least portions of the connection patterns formed on the substrate, for example, the first connection patterns having the pattern isolated from the sensing cells. Therefore, the connection patterns have increased width and are made of a wider range of material, thereby making it possible to obtain the connection patterns having the width capable of being patterned even through the low temperature process performed on the substrate. In addition, even though the opaque metal with low resistance or the conductive material with transmittance having equal or less than a predetermined value is selected as the material for the connection patterns, it is possible to secure the transmittance. Therefore, the visualization of the connection patterns is prevented, such that the visibility is improved.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A flexible touch screen panel, comprising:
a substrate;
first touch sensing cells formed on the substrate and connected to each other in a first direction;
second touch sensing cells formed on the substrate and connected to each other in a second direction intersected with the first direction;
first connection patterns connecting the first touch sensing cells to each other in the first direction; and
second connection patterns connecting the second touch sensing cells to each other in the second direction,
the first connection patterns including at least one opening part.

2. The flexible touch screen panel of claim 1, wherein each of the first connection patterns is a porous pattern including a plurality of opening parts.

3. The flexible touch screen panel of claim 1, wherein the first connection patterns are made of one or more selected from a group consisting of opaque metal material, conductive thin film, silver nanowire (AgNW) conductive thin film, and indium tin oxide (ITO) conductive thin film.

4. The flexible touch screen panel of claim 1, further comprising an insulation film interposed between the first connection patterns and the second connection patterns at an intersection portion therebetween.

5. The flexible touch screen panel of claim 1, wherein the substrate is a thin film substrate and made of one or more material selected from a group consisting of polyethylene terephthalate (PET), polycarbonate (PC), triacetylcellulose (TAC), polyethersulpon (PES), and polyimide (PI).

6. The flexible touch screen panel of claim 1, wherein each of the first connection patterns includes a contact area overlapping one of the first sensing cells and a non-contact area defined as a remaining area with the exception of the contact area, and the at least one opening part is formed in the non-contact area.

7. The flexible touch screen panel of claim 6, wherein the at least one opening part is formed in the contact area as well as the non-contact area.

8. The flexible touch screen panel of claim 6, wherein the at least one opening part comprises a plurality of opening parts uniformly disposed in each of the first connection patterns including the contact area and the non-contact area.

9. A fabricating method of a flexible touch screen panel, the fabricating method comprising:
forming first touch sensing cells and second touch sensing cells on a substrate;
forming a conductive thin film on the substrate;
disposing a first mask layer on the conductive thin film, the first mask layer connecting the first sensing cells to each other in a first direction;
forming first connection patterns by patterning the conductive thin film through the first mask layer, and removing the first mask layer, the first connection patterns connecting the first touch sensing cells to each other in the first direction;
disposing a second mask layer having at least one opening part formed at the first connection patterns on the substrate, the at least one opening part exposing a portion of the first connection patterns; and
forming at least one opening part at the exposed portion of the first connection patterns by using the second mask layer, and removing the second mask layer.

10. The fabricating method of a flexible touch screen panel of claim 9, wherein each of the first and second mask layers is a temporarily hardened dry film resistor.

11. The fabricating method of the flexible touch screen panel of claim 10, wherein each of the first and second mask layers is disposed on the conductive thin film or on the substrate in which the first connection patterns are formed by laminating the dry film resistor.

12. The fabricating method of a flexible touch screen panel of claim 9, wherein the second mask layer is disposed on the entire surface of the substrate on which the first connection patterns are formed.

13. The fabricating method of a flexible touch screen panel of claim 9, further comprising forming second connection patterns connecting the second sensing cells to each other in a second direction intersected with the first direction.

14. The fabricating method of a flexible touch screen panel of claim 13, further comprising forming an insulating film interposed between the first connection patterns and the second connection patterns.

15. A fabricating method of a flexible touch screen panel, the fabricating method comprising:
forming first touch sensing cells and second touch sensing cells on a substrate;
forming a conductive thin film on the substrate;
forming a mask layer on the conductive thin film, the mask layer having at least one opening part and connecting the first sensing cells to each other in a first direction; and
forming first connection patterns by patterning the conductive thin film through the mask layer, and removing the first mask layer, the first connection patterns connecting the first sensing cells to each other in the first direction.

16. The fabricating method of a flexible touch screen panel of claim 15, wherein the mask layer is a temporarily hardened dry film resistor.

17. The fabricating method of a flexible touch screen panel of claim 15, further comprising forming second connection patterns connecting the second sensing cells to each other in a second direction intersected with the first direction.

18. The fabricating method of a flexible touch screen panel of claim 16, further comprising forming an insulating film interposed between the first connection patterns and the second connection patterns.
